(19) United States
(12) Patent Application Publication
(10) Pub. No.: US 2017/0191946 A1
(43) Pub. Date: Jul. 6, 2017

(54) APPARATUS FOR AND METHOD OF INSPECTING SURFACE TOPOGRAPHY OF A MOVING OBJECT

(71) Applicants: UNIVERSITY OF THE WEST OF ENGLAND, BRISTOL, Bristol (GB); THE GOVERNOR AND COMPANY OF THE BANK OF ENGLAND, London (GB)

(72) Inventors: Melvyn SMITH, Bristol (GB); Lyndon SMITH, Bristol (GB); Abdul FAROOQ, Bristol (GB); David Jesse FINNEGAN, Bristol (GB); Ian CROOK, Bodelwyddan, Rhyl, North Wales (GB)

(21) Appl. No.: 15/315,280

(22) PCT Filed: Jun. 5, 2015
(86) PCT No.: PCT/GB2015/051639

§ 371 Date: Nov. 30, 2016

(30) Foreign Application Priority Data
Jun. 5, 2014 (GB) 1410019.2

(51) Int. Cl. G01N 21/892; G06T 7/00; G07D 7/12; G01N 21/89

(52) U.S. Cl. CPC G01N 21/892; G01N 21/89; G06T 7/00; G07D 7/12

(57) ABSTRACT

A dynamic photometric stereo inspection technique usable to capture and analyse the topography of a moving surface. The technique includes an enhanced data capture method and apparatus comprising a spaced array of at least two coplanar illuminates to improve measurement range and accuracy. The apparatus can be used to inspect banknotes, e.g. to assist with fitness assessment and/or forgery detection. The method may comprise automatically assessing surface topography data to provide qualitative and quantitative information about 2D and 3D features, such as changes in reflectivity, colour, glossiness, 3D texture and the surface profile of the surface under inspection.

### FIELD OF THE INVENTION

The invention relates to a method and an apparatus for inspecting surfaces moving at high speeds. In particular, the invention relates to the use of a dynamic photometric stereo detection technique for identifying defects in a surface topography, e.g. in the surface of a sheet of material such as a banknote.

### BACKGROUND TO THE INVENTION

Products such as steel strips, wood, or paper are typically produced in a continuous process. It is common to inspect the material during motion. The inspection may form part of a process control technique, e.g. to detect for compliance with set tolerance limits or to detect defects.

A considerable amount of research on 2D and 3D analysis of moving surfaces has been undertaken, employing techniques that have ranged from laser triangulation to systems employing multiple lights and/or cameras. Such systems are used in industrial applications such as the inspection of steel, tiles or wood. The applied cameras are usually line scanners and can obtain monochrome or colour images. For illumination, Light Emitting Diodes (LEDs), fluorescent lamps, halogen lamps or fibre optic illuminators are commonly employed. The defects to be detected and measured are, for example, two-dimensional features such as colour, or three-dimensional features such as scratches, dents, and knots, the exact characteristics of which depend upon the application.

One industry in which automated surface inspection systems are widely used is currency processing, i.e. determining the fitness of banknotes. Banknotes may be classified as unfit for circulation if they fail to meet certain criteria, e.g. crumpling, tears (both open and closed), ink wear, marking or other soiling. However, automated detection of defects is difficult. For example, defects such as tears may be coincident with colouring defects such as lines drawn (graffiti) on a banknote. It is also difficult to distinguish banknotes that have their corners missing (which are not legal tender) from banknotes which simply have folded corners (which are legal tender). Current conventional banknote imaging techniques are unable to reliably distinguish between these kinds of features, often leading to unsatisfactory performance through feature misinterpretation.

The currency processing authorities must always strike a balance between allowing the continued circulation of unfit notes and destroying fit notes. There is therefore a desire for an automated inspection system that can repeatably and accurately classify surface defects (in both two and three dimensions) in a qualitative and quantitative manner. It is especially desirable for such inspection to be performed at a high rate, i.e. on rapidly moving surfaces.

Many known banknote inspection system employ image processing, i.e. the analysis and/or comparison of captured images. Current systems that are installed on banknote sorting machines typically employ line scan cameras and LED line lights, to recover 2D images of each note passing through the machine. One drawback of a purely 2D approach is that certain features, e.g. crumpling, tears, folded or torn corners and the presence of tape, cannot be reliably detected.

Measurement of 2D and 3D characteristics of banknotes is also used for quality control and authentication of banknotes. Here the conventional line scan image capture approach described above is applied; however, the fact that it is only 2D and the limited resolution that is often employed on systems that process notes at high speed, mean that the functionality of the existing systems is limited.

U.S. Pat. No. 8,265,346 uses a line scanner and multimode illumination to obtain a plurality of images of a banknote surface that can be projected on to an empirically determined fitness vector to yield a fitness value for a given bank note.

EP 2 057 609 discloses an inspection technique where the surface is illuminated by angled light so that the captured image include reflections and shadows caused by raised material in the banknote.

U.S. Pat. No. 6,166,393 discloses an inspection technique in which images of a moving surface are captured under three different illumination conditions. The three illumination conditions are provided by different incident angles for the inspection light, which correspond to a bright field and two dark fields. The detected image signal intensities are manipulated to obtain information about the surface, such as glossiness, reflectivity and slope.

U.S. Pat. No. 8,363,903 discloses a technique in which a plurality of images are captured by shining different lights at a moving surface located next to a reference area that is under constant illumination. The reference area assists with registration of a given point on the surface with points in the images formed under the different illuminations.

U.S. Pat. No. 8,444,821 discloses a method of analysing a web surface by pulsing LEDs with different optical bands onto the web in a time window that is less than 2 microseconds.

W0 2010/010229 describes analysing a moving surface by capturing images through use of frequency multiplexing that employs light with specific wavelengths with corresponding filters in the camera device (i.e. analogous to a multi-sensor colour TV camera).

U.S. Pat. No. 6,327,374 describes analysing moving surfaces by capturing images through use of temporal multiplexing.

### SUMMARY OF THE INVENTION

At its most general, the present invention proposes using a dynamic photometric stereo inspection technique to capture and analyse the topography of a moving surface. This general concept encompasses several independent inventive aspects, which can be expressed generally as:

(i) an enhanced data capture method and apparatus which yields richer (more comprehensive and/or more sensitive) data, and which operates effectively even if the inspected surface is moving at high speed;

(ii) a banknote inspection apparatus and method that employs a dynamic photometric stereo inspection technique to assist with any one or more of fitness assessment, forgery detection and manufacturing process control; and

(iii) a data analysis technique capable of delivering qualitative and quantitative information about 2D and 3D defects.

The present invention makes use of photometric stereo (PS), which is a machine vision technique for recovering 3D surface normal data (known as a ‘bump map’) and 2D reflectance data (known as albedo) from surfaces. Photometric stereo employs a number of lights in known locations and a single camera [1-4]. An image is captured when one of each of the lights is turned on in turn. The obtained images are processed and combined using a lighting model (such as Lambert's Law, which assumes that the brightness of a pixel at a point on the surface is proportional to the cosine of the angle between the vector from the point to the source and the surface normal vector at that point), in order to generate the bump map (i.e. a dense array of surface normals sometimes referred to as 2.5D data) and the albedo (an image of surface reflectance).

FIG. 1 shows a schematic view of an apparatus for performing photometric stereo measurements. A plurality of light sources (which are also referred to as illuminates) S1, S2, S3 are positioned above a surface 10 to be inspected, which lies in the field of view of a camera 12. The position of the light sources relative to the surface are known accurately, so that an incident light vector from each source is known for each point on the surface. To fully recover the orientation of a surface normal N in a three-dimensional coordinate system (e.g. formed by axes X, Y, Z), a minimum of three light sources are required to be arranged in a manner whereby, between them, the incident vectors provide components along all three axes.

Photometric stereo differs from the conventional imaging techniques mentioned above in that the captured images are combined using the lighting model to generate the bump map and albedo (on which further assessment is based), whereas the conventional techniques simply compare raw image data.

The present invention is based on the technique of dynamic photometric stereo, in which various multiplexing techniques can be used to analyse moving surfaces [5, 6].

FIG. 2 shows a schematic view of one form of apparatus for performing dynamic photometric stereo measurements. In this arrangement there is a moving surface 14 that is continuously traversing through the field of view of the camera 12. In order to achieve the necessary intensity distribution required for the imaging of moving surfaces at production rates it is necessary to use a distributed light source. In FIG. 2, there are two light sources 16, 18. Each light source 16, 18 is a line light (i.e. produces a planar light beam that appears as a line 20 on the surface 14), which may comprise any of a fluorescent tube, a linear array of fibre optics or a plurality of high intensity LEDs. Although these light sources 16, 18 are not point sources and therefore would appear to cause uncertainty in the direction of the light source vector at a point on the line 20 on the surface, it has been shown that, if occlusion and inverse square effects are ignored, any group of real point sources can be replaced by an equivalent virtual point source [5]. This allows the incident light vectors at each point on the line 20 to be treated as being along the shortest distance from the lights sources 16, 18.

It is important to note that FIG. 2 does not show a simple line-scan 2D image capture from a surface. Rather, it represents a dynamic photometric stereo surface analysis, where the angles of the illuminates 16, 18 relative to the plane of the moving surface 14 are known precisely and are used, in combination with a lighting model such as Lambert's Law, for direct recovery of the 3D and 2D textures from the surface [5, 6].

### Enhanced Data Capture

A first aspect of the invention relates to a method and apparatus for collecting a richer data set without necessarily causing a proportional increase in processing demand. This is achieved by providing a spaced array of at least two, but preferably three or more in-plane illuminates (i.e. sources of illumination). By providing more illuminates, the available measurement range and accuracy is improved, but by reducing the dimensionality of the collecting data (i.e. by consciously allowing ambiguity in a given direction) the processing demand can be kept at a manageable level.

According to the first aspect of the invention, there may be provided a method for inspecting a surface, the method comprising: illuminating a surface with three or more inspection beams, each inspection beam being output from a respective illuminate, the illuminates being spaced from each other over the surface; obtaining a plurality of digital images of the surface from a digital image capturing device; and calculating a magnitude and a direction for a surface normal component at each of a plurality of inspection points on the surface based on the plurality of digital images and a predetermined incident light vector from each of the illuminates at each inspection point, wherein the illuminates are arranged relative to the surface so that their predetermined incident light vectors are coplanar at each inspection point.

Herein the noun “illuminate” is used to mean a source of illumination. The illumination may be visible light or infra red radiation or ultra violet radiation. The illuminates may be spaced over the inspection plane in a symmetrical or asymmetrical fashion to further facilitate surface recovery. The illuminates may comprise any type of light source that is able to illuminate one or more inspection points on the inspection plane in a manner that yields an unambiguous incident light vector. For example, the illuminates may comprise line lights (e.g. made of a fluorescent tube or more preferably a row of high intensity LEDs) that emit a planar beam of light that intersects the inspection plane along a line. It is known that the incident light vector for each point on the line can be treated as the shortest distance from that point to the light source. Accordingly, a set of parallel line lights will provide coplanar incident vectors. However, other lighting distributions can be used to yield the same effect. For example, the three or more illuminates may include a virtual illuminate created by simultaneous illumination of the surface with the inspection beams from two or more physical illuminates.

The method is applicable to dynamic measurement situations, e.g. where the surface moves relative to the digital image capturing device while the plurality of digital images is obtained. The surface may thus move through the inspection plane during the image capture process. The inspection plane may be smaller than the surface that is being inspected.

The illuminates may only illuminate a portion of the moving surface at any given moment. The digital image capture device may thus need to assemble a full image of the surface for each respective illuminate from a series of sub-images of different portions of the surface. The digital image capture device may thus need to be synchronised with the movement of the surface to ensure that the collected sub-images for each illuminate form a complete image of the surface.

The step of calculating the magnitude and direction for the surface normal component at each inspection point may be performed using known photometric stereo techniques. For example, this step may include applying a surface reflectance lighting model to a detected light intensity at each inspection point obtained and the predetermined incident light vectors from the illuminates at each inspection point. The lighting model may be a Lambertian reflection model, a specular reflection model, or the like. In this aspect of the invention, reference is made to a surface normal component because only the component of the full surface normal that lies in the plane of the predetermined incident light vectors can be calculated.

The calculated surface normal component data may be further analysed to determine information about the surface. The method may include generating inspection data from the magnitude and direction of the surface normal components of the inspection points; and analysing the inspection data to identify properties, e.g. physical properties concerning the shape and integrity of the surface.

Analysing the inspection data may comprise comparing the behaviour of the surface normal components across the surface with characteristic surface normal behaviour associated with one or more surface defects. This type of comparison may facilitate rapid qualitative assessment of the surface. The method may include an initial filtering step that compares the behaviour of the surface normal components with an expected norm to identify sub-regions of the surface that warrant further investigation. This filtering step may reduce the overall processing burden.

The surface may belong to a sheet-like object, such as paper. In one embodiment, the surface may belong to a banknote. The one or more surface defects may include tearing, folding, soiling and crumpling.

An advantage of having three or more illuminates is that a wider range of information can be gleaned from the photometric stereo measurements. This is a result of being able to obtain information from a wide range of incident angles on the surface. Moreover, in addition to being able to detect a wide range of surface normals, the detected images may also provide shadow patterns (for flat incident rays) and specular information (for incident originating near the digital image capturing device or where the surface normal bisects the incident and camera view vectors). The step of analysing the inspection data may thus comprise determining specular properties of the surface. The specular properties may give information about the presence of a transparent layer mounted on the surface.

Thus, the inspection data may comprise the typical outputs of a photometric stereo measurement, i.e. one or more of a bump map comprising a dense array of the surface normal component directions calculated for the plurality of inspection points, and an albedo comprising a map of the surface normal component magnitudes calculated for the plurality of inspection points. In addition, the inspection data may further include any one or more of: a shadow pattern obtained from one or more of the plurality of digital images, and a full colour image of the surface. The full colour image may be registered with the bump map to resolve any ambiguity between surface normal direction and surface colour.

The step of illuminating the surface may include multiplexing the inspection beams in any of a temporal sense, spatial sense or spectral sense (or a combination thereof). The data gathered by the digital image capturing device may thus form a plurality of channels, e.g. one channel for each illuminate or for each illumination direction (incident vector). The digital image capturing device may comprise a plurality of cameras, e.g. one camera for each channel. Each camera may be a line-scan camera, although any suitable image sensor (e.g. based on CCD, CMOS or CIS technology) may be used. Alternatively a single camera may be used, but may have different regions of its field of view allocated to different channels. Both solutions permit multiple channels to be received simultaneously.

The method may be carried out under the control of a computer-operated scheduler, which can coordinate movement of the surface with activation of the illuminates and operation of the digital image capturing device.

The first aspect of the invention may also be expressed as an apparatus for inspecting a surface, the apparatus comprising: three or more illuminates mounted in a spaced arrangement over an inspection plane, each of the three or more illuminates being arranged to output an inspection beam to illuminate a region of the inspection plane; a digital image capturing device having the inspection plane in its field of view; and a processor arranged to receive a plurality of digital images from the digital image capturing device, each of the plurality of digital images including an image of the inspection plane when illuminated by an inspection beam from a respective illuminate, wherein the processor is arranged to calculate a magnitude and a direction for a surface normal component at each of a plurality of inspection points on the inspection plane based on the plurality of digital images and a predetermined incident light vector from each of the illuminates at each inspection point, and wherein the three or more illuminates are arranged so that their predetermined incident light vectors are coplanar at each inspection point.

Features mentioned with respect to the method above are also applicable to the apparatus. For example, the apparatus may include an object conveyor arranged to move a surface to be inspected across the inspection plane while the plurality of digital images are captured by the digital image capturing device.

As mentioned above, each of the three or more illuminates may comprise a line light for outputting a planar light beam that intersects with the inspection plane along an inspection line. The digital image capturing device may thus be arranged to build each of the plurality of images from a plurality of imaged inspection lines.

In one implementation, the three or more illuminates may output illumination in different discrete wavelength bands, and wherein the planar light beams from the three or more illuminates intersect with the inspection plane along a common inspection line. In this case the digital image capturing device may comprise a plurality of imager sensors that are sensitive to a respective one of the discrete wavelength bands.

However, to simplify the manipulation of the illumination received by the digital image capturing device, the inspection lines of the three or more illuminates preferably lie adjacent one another on the inspection plane, i.e. they are spatially separated.

As mentioned above, the illuminates may be physical or virtual. However at least two physical illuminates are needed to generate a virtual illuminate. In an alternative implementation of this aspect of the invention, the coplanar incident vectors can be provided by a single illuminate by curving the inspection plane. According to this alternative implementation, there may be provided an apparatus for inspecting a surface, the apparatus comprising: an illuminate mounted adjacent to a predefined travel path for a inspection surface, the illuminate being arranged to output an inspection beam to illuminate a region of the inspection surface as it moves relative to the illuminate; a digital image capturing device having the illuminated region of the inspection surface in its field of view; and a processor arranged to receive a plurality of time-spaced digital images from the digital image capturing device, wherein the region of the inspection surface in the field of view of the digital image capturing device is curved; wherein the processor is arranged to calculate a magnitude and a direction for a surface normal component at each of a plurality of inspection points on the inspection surface based on the time-spaced plurality of digital images and a set of predetermined incident light vectors from the illuminate at each inspection point in each of the time-spaced plurality of digital images, and wherein the set of predetermined incident light vectors for each inspection point are coplanar. The apparatus is therefore an example of a combination of spatial and temporal multiplexing, in which a non-planar inspection surface enables a single illuminate source to provide a series of different incident vectors for a given inspection point.

In a further implementation, the coplanar incident vectors can be provided by a single illuminate that moves relative to the inspection plane.

### Banknote Inspection

In a second aspect, the invention provides a banknote inspection apparatus that is based on dynamic photometric stereo measurements. The aim of this aspect of the invention is to capture surface data that contains the necessary information to detect and to distinguish relevant surface defects automatically.

According to the second aspect of the invention there is provided an inspection apparatus for banknotes, comprising: a feed mechanism for conveying a banknote across an inspection plane; and a photometric stereo measurement system arranged to detect a surface topography of the banknote as it passes across the inspection plane; and an analysis processor arranged to identify defects in the banknote from the detected surface topography. The use of photometric stereo measurements enables the analysis to be based on three-dimensional surface gradient over the banknote, which permits defects to be determined with greater confidence than known pure imaging methods.

The photometric stereo measurement system may comprise a plurality of illuminates mounted in a spaced arrangement over the inspection plane, each of the plurality of illuminates being arranged to output an inspection beam to illuminate a region of the inspection plane; and a digital image capturing device having the inspection plane in its field of view, wherein the digital image capturing device is arranged to capture a plurality of images, each image being of the surface in the inspection plane when illuminated by an inspection beam from a respective illuminate. The photometric stereo measurement system may be configured as described in the first aspect of the invention as discussed above. This may be desirable, especially if the banknotes are moving at high speeds, but it need not be essential.

Thus, the second aspect of the invention may employ illumination from two or more sources and image capture by means of one or more cameras, with multiplexing and high-speed image processing. The analysis processor may perform surface normal (and albedo) analysis to model 2D and 3D sheet features, and to identify and quantify defects/characteristics of rapidly moving surfaces.

The analysis processor may be arranged to calculate a magnitude and a direction for a surface normal component (or for a full surface normal) at each of a plurality of inspection points on the inspection plane based on the plurality of digital images and a predetermined incident light vector from each of the illuminates at each inspection point. The analysis processor may generate inspection data from the magnitude and direction of the surface normals or surface normal components of the inspection points, and to analyse the inspection data to identify defects in the banknote. The defects may include any one of tearing, folding, soiling and crumpling.

The analysis processor is further arranged to determine specular properties of the banknote from the surface topography, e.g. to detect for the presence of transparent tape on the banknote.

The apparatus may be arranged to perform any or all of the analysis techniques mentioned in the third aspect below.

The apparatus of the second aspect of the invention may be adapted to operate at a high throughput, e.g. a surface moving relative to the digital image capturing device at a speed in excess of 2 ms⁻¹, e.g. 5 ms⁻¹ or more, up to 10 ms⁻¹ or more. Whilst the volume of input data and the processing demand can be controlled somewhat by using in-line illuminates, the components of the apparatus may also be chosen with rapid processing in mind.

Thus, the digital image capture device may comprise one or more high speed camera(s) such as high performance line-scan cameras or multi-region area arrays or contact image sensor (CIS). The illuminates themselves may be high intensity LED arrays capable for emitting a sheet of substantially collimated light.

The analysis processor may comprise a dedicated Graphics Processor Unit (GPU) on a parallel computing platform. The digital image capturing device may communicate with the GPU via an interface unit that has an inbuilt FPGA, to enable a rapid flow of data to the GPU. The GPU may output the bump map and albedo, which can be assessed using suitable comparison routines running on a conventional CPU.

### Data Analysis

The third aspect of the invention provides a computer implemented method of automatically assessing surface topography data obtained from a photometric stereo measurement to identify (e.g. detect and classify) surfaces anomalies in the form of 2D and 3D features. For example, the third aspect of the invention may be applied to detect and classify any one or more of changes in reflectivity, colour, glossiness, 3D texture and the surface profile of the surface under inspection. Such information may be useful in checking the authenticity of documents or in providing process control information for a manufacturing assembly.

The third aspect of the invention may be applied in particular to the analysis of the inspection data generated for a banknote surface using the apparatus of the second aspect of the invention. In this case, the third aspect of the invention may be applied to detect and classify surface defects and/or covert and/or overt security features.

According to the third aspect of the invention there is provided a method of analysing surface topography of a moving surface, the method comprising: obtaining a bump map comprising a dense array of surface normal component directions for a plurality of inspection points on a surface; modelling the behaviour of the surface normal component directions in a region of the surface; and identifying a property of the surface based on the modelled behaviour. The surface normal data may provide three-dimensional information about the surface topography that is absent from pure image data. This may allow the properties of the surface to be automatically determined with greater confidence.

The step of modelling the behaviour of the surface normal component directions may include fitting the surface normal directions across the region to a polynomial expression. This may be achieved by formatting surface normal angle data into a discrete and/or continuous form in one or more directions across the surface.

The step of modelling the behaviour of the surface normal component directions may include employing a neural network to characterise a surface feature.

In one implementation, the step of modelling the behaviour of the surface normal component directions may include fitting the rate of angular change of the surface normal directions across the region to a polynomial expression.

The bump map may be part of a set of surface topography data obtained from a photometric stereo measurement. The surface topography data may further include an albedo and/or a shadow pattern for the surface to be analysed. The albedo may be analysed to determined specular data (i.e. data concerning the reflectivity or glossiness of the surface). The shadow pattern may be analysed to assist in the identification and quantification of surface discontinuities.

The step of identifying a property of the surface may include comparing the modelled behaviour with predetermined characteristic behaviour of known surface properties. The characteristic behaviour may be stored in look up table where it can be accessed to determine similarity with a modelled feature.

The known surface properties may include surface defects, such as tearing, folding, soiling, crumpling and the presence of tape. Alternatively or additionally, the known surface properties may include overt or covert security features.

The step of identifying a property of the surface includes quantifying the surface defect, e.g. in terms of size, shape, position, severity, etc.

In another implementation, the step of modelling the behaviour of the surface normal component directions may include creating a computer-generated three-dimensional rendering of the region from the bump map; generating a first view of the computer-generated three-dimensional rendering using a first illumination location; and generating a second view of the computer-generated three-dimensional rendering using a second illumination location that is different to the first illumination location, wherein identifying a property of the surface includes comparing the first view with the second view. In other words, having the bump map enables the generation of a virtual rendering of the surface topography using a variety of illumination conditions. It may be possible to resolve any ambiguity in the nature of an identified surface feature by observing it (in a virtual manner) using different illumination conditions. It is also possible to make small 3D defects more visible by either slightly perturbing the normals or by rendering the surface using a specular reflection model. This has the effect of achieving a kind of ‘3D shape amplification’, making small 3D features significantly more apparent.

As mentioned above, the third aspect of the invention may be used to analyse the surface of a banknote. In this case, the method may include using the identified property of the surface to determine the fitness of the banknote.

### BRIEF DESCRIPTION OF THE DRAWINGS

Examples of the invention are discussed below in detail with reference to the accompanying drawings, in which:

FIG. 1 is a schematic view of a known photometric stereo measurement setup, and is discussed above;

FIG. 2 is a schematic view of a known dynamic photometric stereo measurement setup, and is discussed above;

FIG. 3 is a cross-sectional view of a photometric stereo measurement setup with closely spaced illuminates;

FIG. 4 is a cross-sectional view of a photometric stereo measurement setup with widely spaced illuminates;

FIG. 5 is a cross-sectional view of a photometric stereo measurement setup with a plurality of in plane illuminates;

FIG. 6 is a schematic view of a dynamic photometric stereo measurement setup that is an embodiment of the invention;

FIG. 7 is a cross-sectional view of a photometric stereo measurement setup with a plurality of in plane illuminates that illustrates the effect of a surface discontinuity;

FIG. 8 is a cross-sectional view of a dynamic photometric stereo measurement setup that is another embodiment of the invention;

FIG. 9 is a schematic view of a frequency multiplexing technique that can be used with the dynamic photometric stereo measurement setup of the invention;

FIG. 10 is a schematic view of a spatial multiplexing technique that can be used with the dynamic photometric stereo measurement setup of the invention;

FIG. 11 is a schematic view of a hybrid spectral-spatial multiplexing technique that can be used with the dynamic photometric stereo measurement setup of the invention;

FIGS. 12A, 12B and 12C are schematic cross-sectional views of different surface defect that may be characterised by the dynamic photometric stereo measurement setup of the invention.

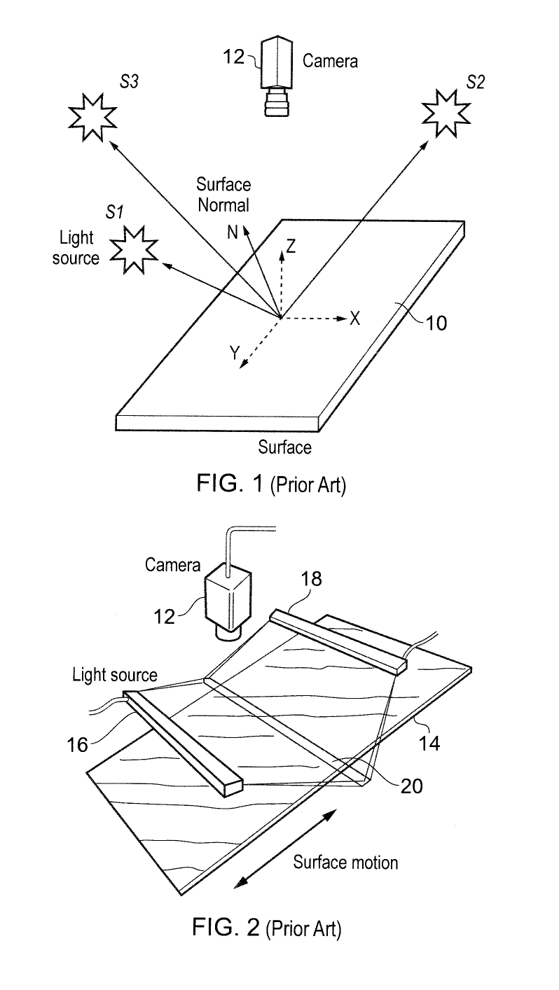

### DETAILED DESCRIPTION; FURTHER OPTIONS AND PREFERENCES

### Enhanced Data Capture

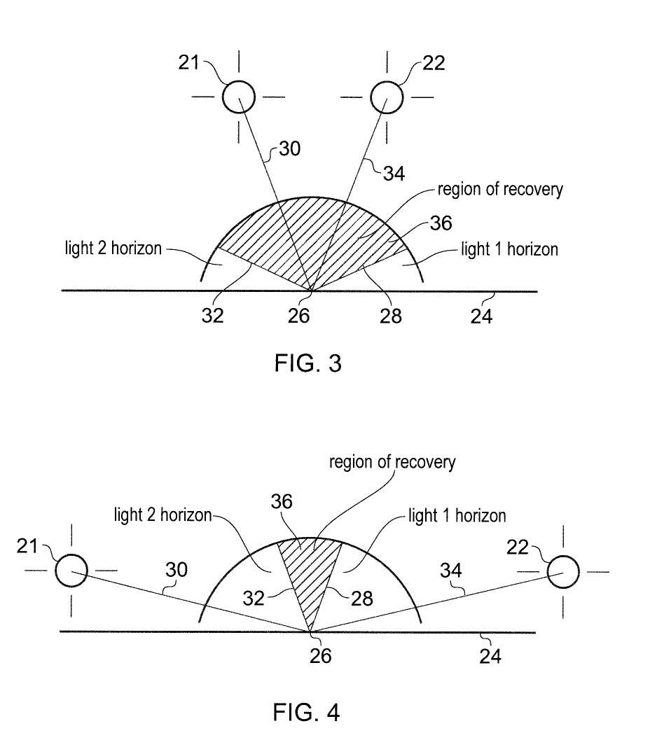

The principle behind the enhanced data capture technique of the invention is now explained with reference to FIGS. 3 to 8.

In known photometric stereo arrangements, a compromise is struck between the sensitivity and accuracy of a measurement and the range over which measurements can be made. The closer together illuminates are placed, the greater is the range of surface normal recovery (i.e. the wider the range of surface normal angles that will be detected). However, the further apart the illuminates are placed, the greater is the sensitivity and accuracy in the surface normal recovery.

FIG. 3 shows a cross-sectional view of a photometric stereo measurement setup with closely spaced illuminates 21, 22 above an inspection surface 24. The illuminates 21, 22 may be point sources or line sources. The range of surface normal angles that can be recovered for a given inspection point 26 ranges between the horizon 28 that is orthogonal to the incident vector 30 from the first light source 21 to the horizon 32 that is orthogonal to the incident vector 34 from the second light source 22. This yields a large region of recovery 36, but with low sensitivity, i.e. images of 3D topography obtained using illuminates 21 and 22 tend to be similar.

In contrast, FIG. 4 shows a cross-sectional view of a photometric stereo measurement setup with widely spaced illuminates 21, 22 above an inspection surface 24. Again, the range of surface normal angles that can be recovered for a given inspection point 26 ranges between the horizon 28 that is orthogonal to the incident vector 30 from the first light source 21 to the horizon 32 that is orthogonal to the incident vector 34 from the second light source 22. In this case this yields a small region of recovery 36, but with high sensitivity, i.e. images of 3D topography obtained using illuminates 21 and 22 tend to very different.

The enhanced data capture technique of the present invention is based on the concept of multiple in-plane illumination, i.e. using more than two, e.g. three, four, five, six or more, illuminates arranged so that the incident vectors they provide for a given inspection point are coplanar. This arrangement provides redundancy that can be exploited to achieve higher accuracy as each illuminate contributes to defining the unknown normal.

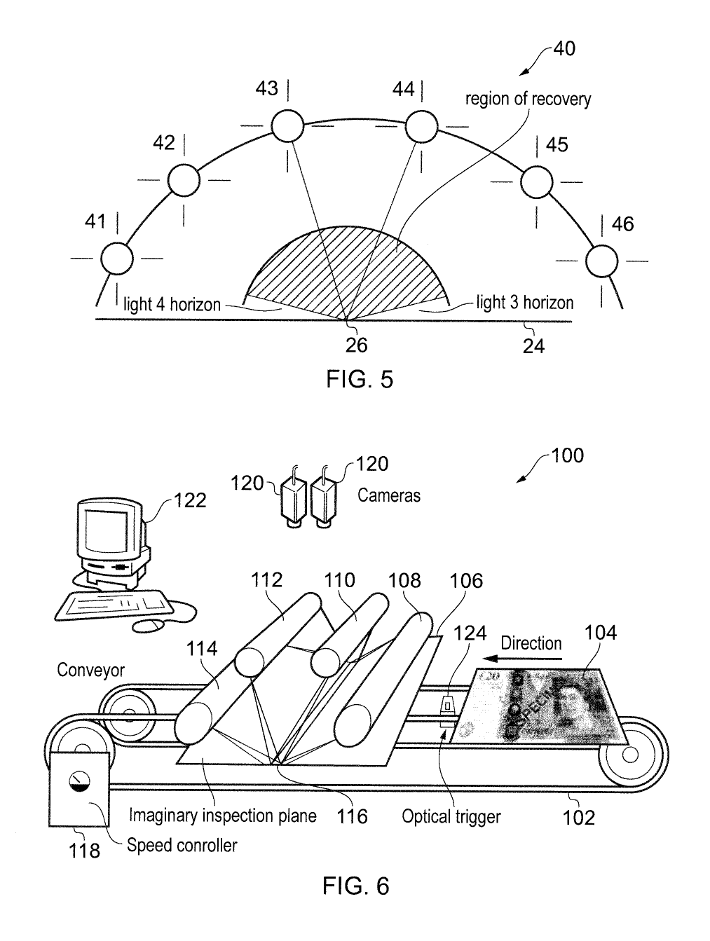

FIG. 5 shows a cross-sectional view of a photometric stereo measurement apparatus 40 that is an embodiment of the invention. In this arrangement, six illuminates 41-46 are arranged over an inspection surface 24. The illuminates 41-16 are arranged such that the incident vectors used to calculate a surface normal at an inspection point 26 on the surface 24 are coplanar (in the plane of the page).

In known photometric stereo techniques, additional in-plane illuminates are avoided because they do not contribute further to the location of the normal in a three-dimensional coordinate system. However, the inventors have realised that the redundancy provided by additional in-plane illuminates can be exploited to particularly good effect where features of interest on the surface are very small.

In-plane illumination captures the component of the unknown surface normals in the plane formed by the illuminates only. This means that features that are entirely orthogonal to this plane will be missing. In practice, because real features are not perfect, this does not have a material effect. However, one or more additional illuminates may be provided out of the plane if it is desirable to resolve the remaining dimension of the surface normal. Multiple planes could be used to recover the full surface normal with increased sensitivity and accuracy. However, in certain applications, e.g. banknote inspection, it is possible to implement an inspection system with only the plurality of in plane illuminates, as these may give enough information about surface defects that are of interest.

In use, the multiple in-plane illuminates can provide both a wide range of recovery and high sensitivity. The lights which are far apart will give higher sensitivity, whereas by using multiple pairs we can obtain an overlapping region of recovery that is wider than can be achieved with only two illuminates. For example, a series of measurements for the inspection point 26 may be taken using different pairs of the illuminates, e.g. lights 41 and 43, then lights 42 and 44, then lights 43 and 45, then lights 44 and 46.

The illuminates 41-46 are arranged symmetrically over the inspection surface 24. This may facilitate more rapid processing, but is not essential.

The illuminates 41-46 may also be operated in combination to create virtual light sources at different locations. For example, in another embodiment lights 42 and 45 may not be physical light sources, but may instead be created by simultaneous operation of lights 41 and 43 and lights 44 and 46 respectively.

FIG. 6 is a schematic view of a banknote inspection apparatus 100 that incorporates the ideas above and which is an embodiment of the invention. The apparatus 100 comprises an object feed mechanism 102, which in this case is a conveyor for moving banknotes through an inspection plane 106. In FIG. 6 the banknote 104 is shown lying flat on the conveyor, but the present invention may also operate with non-flat surfaces as discussed below with reference to FIG. 8. The conveyor may be arranged to orientate the object to be inspected in a manner that accentuates the visibility of the features being detected.

A plurality of light sources 108, 110, 112, 114 are arranged over the inspection plane 106. Each light source 108, 110, 112, 114 generates a planar light beam which intersects the inspection plane 106 along a line. In this embodiment, the planar light beams overlap on the inspection plane along a common inspection line 116, which implies that a form of spectral multiplexing will be used (see below). However, in other embodiments the planar light beams may illuminate different areas on the inspection plane.

In this embodiment, each light source is a line light, e.g. comprising a plurality of high intensity LEDs arranged in a row. The light sources are parallel to one another. Each LED in the line produces a collimated beam to generate a composite planar beam. As discussed above, at each inspection point on the surface the planar beam may be treated as a single incident vector that extends the shortest distance between the inspection plane and the light source at that point. Each point on the common inspection line is therefore exposable to a plurality of light sources whose incident vectors lie in a common plane. An advantage of this arrangement is that it provides richer output data without a proportional change in image processing demand.

The illuminates 108, 110, 112, 114 may comprise broad band or narrow band sources of one or more wavelengths. As mentioned above, various combinations of wavelengths can be employed for implementing frequency multiplexing. For example, near infra-red illumination and or visible wavelengths may be used. Similarly, one or more of the illuminates may have a frequency (e.g. in the ultra violet or infra red range) selected to image a feature of interest on the surface that is sensitive to that frequency.

In another embodiment, the incident light may be polarised so that changes in polarisation upon reflection can be detected. Thus, a polarising filter may be placed in front of an illuminate and another filter, at 90° to the first, may be placed in front of the camera. This technique may be used for detecting the presence of different materials on the surface, e.g. transparent tape on a banknote.

In another embodiment, the incident light may be coherent, e.g. from a laser. The illuminate may comprise a laser source for outputting a beam of laser light, and an optical system, e.g. including a cylindrical lens, for manipulating the beam of laser light into an incident beam (e.g. an planar beam) on the inspection surface. In this arrangement, the light reflected from the inspection surface may be projected on a screen located in the field of view of the camera. The reflected light may form a pattern on the screen which may be indicative of the condition of the surface, i.e. may be influenced by the 3D texture and features on the note surface. This technique may be used in addition to photometric stereo (PS). The laser technique might be useful for detecting rather more specular features, such as tape or the varnish that is applied to the inspection surface.

Returning to FIG. 6, the inspection plane is located in the field of view of an image capture device, which in this embodiment comprises a pair of digital cameras 120. Using two (or more) cameras may increase the speed with which images are captured, but the invention can work with a single device.

A speed controller 118 may be provided on the conveyor to control the speed at which the object moves through the inspection plane. The speed of the object needs to be related to the speed that images are captured from the inspection line in order to allow full images for the object's surface to be generated for each desired illumination angle, e.g. one image for each of the illuminates. An encoder on the conveyor may measure the position of the surface to be inspected with reference to the inspection plane. The image can be built up by using the camera to capture one or more lines at a time. A trigger 124, e.g. an optical sensor or the like, can be used to initiate image capture by detecting a characteristic feature, e.g. an edge or other trigger image, on the object as it approaches the inspection plane.

In order to obtain multiple surface images of the surface of a moving object, some form of multiplexing is required. Any one of the following may be used:
temporal multiplexing: each light source is projected on to the surface at different times. The light can be of any wavelength, as desired. Image capture is synchronised with the activation of each light in sequence.
spatial multiplexing: each light source projects onto a different (i.e. non-overlapping) region of the surface. The lights can be of any wavelength and are projected to different (non-coincident) positions on the inspection plane. Camera scanning then occurs simultaneously at different locations, each image is built up as the surface moves through these locations.
spectral multiplexing: each light source projects a beam at a different predominant wavelength (or band of wavelengths). Spectrally matched sensing is then used to simultaneously acquire the surface images.
hybrid multiplexing: a combination of two or more of the multiplexing methods described above.

Examples of these techniques are discussed in further detail below.

The multiple surface images are sent to a computer processing device 122 for analysis. As mentioned above, the analysis in this case involves generating a bump map and albedo for the surface of the object by applying a lighting model (e.g. Lambert's law) to known information about the output intensity of each source, the incident light vector from each source at each inspection point and the measured intensity at each inspection point.

The use of in-plane illuminates may be particularly useful for detecting discontinuities caused by edge effects. This may be desirable in situations where sensitivity to broken surface (e.g. torn sheet material) is needed. Surface discontinuities can cause a rapid change in the sense of the surface normals in the region of the discontinuity and may also produce a shadow, that may provide useful information. A wide distribution of illuminates allows accurate detection and determination of discontinuities. By monitoring for sudden change between illuminates we can detect discontinuities, e.g. caused by small edges. Shadows manifest themselves as large changes between widely spaced illuminates.

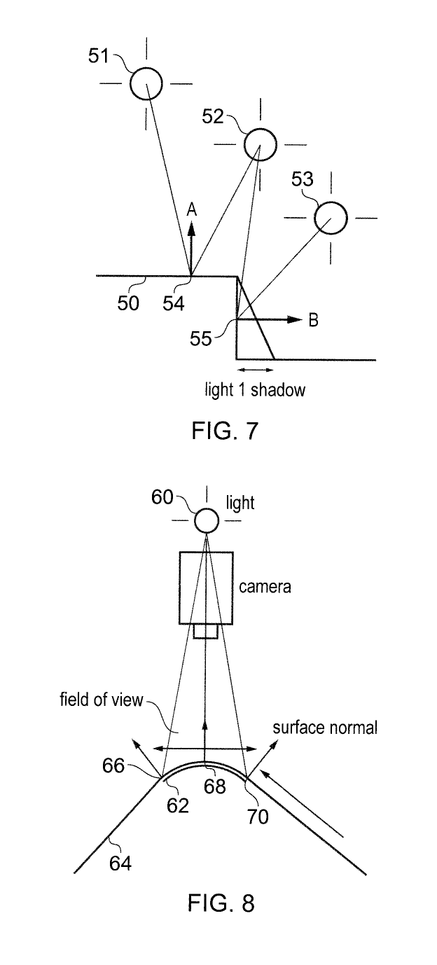

FIG. 7 illustrates how multiple in-line illuminates provide enhanced sensitivity to edge effects. In FIG. 7 a surface 50 with an abrupt step therein is arranged under three in-plane illuminates 51, 52, 53. Incident vectors from illuminates 51, 52 are used to define normal A at a first inspection point 54 while incident vectors from illuminates 52, 53 are used to define normal B at a second inspection point 55. The presence of the step will cause a large difference in the intensities received by illuminate 51 and illuminate 53 (there will be a shadow in the image taken using illuminate 51). The information from all three images is thus richer than that obtained from only two. The shadow pattern obtained using illuminate 51 may itself be a source of useful information in conjunction with the albedo and bump map.

Another advantage of having multiple in-line illuminates is that it is possible to provide an illuminate position close to the camera, which enables detection of specular features, e.g. a significantly increased intensity with a rapid drop-off (i.e. a high rate of intensity change when moving between illuminates). This type of technique may permit reliable detection of foreign objects on a surface under inspection. For example, it may detect the presence of transparent tape on a matt surface (e.g. paper-based or polymer-based banknote) because the ratio of specular reflection to diffuse reflection is expected to be different between the tape and the matt surface.

It is also possible to implement a specular form of the photometric stereo method [7, 8] in order to recover dense surface normal data (perhaps representing a hidden signature) from shiny, glossy specular regions, e.g. a metallic surface or shiny plastic area. This type of photometric stereo analysis may use a specular reflection model rather than a Lambertian (diffuse) reflection model. The same illuminates and image capturing device may be used for the specular photometric stereo measurements as for the normal (diffuse) measurements.

FIG. 8 illustrates schematically an alternative arrangement for providing multiple in-plane illuminates that can be used when the object to be inspected is flexible, e.g. made from a sheet-like material such as paper or flexible plastic (e.g. polypropylene-based banknotes). Instead of providing multiple light source in separate physical locations or moving a single light source between separate physical locations, the arrangement in FIG. 8 uses a single light source 60 in conjunction with a curved inspection area 62, whereby from the point of view of the surface being inspected, the single light source 60 to appears to sweep through space.

Thus, as the flexible surface 64 passes around the curved inspection area 62, the incident vector from the light source has a different angle at different locations on the surface. Spatial multiplexing may be used to generate a series of images of the whole surface corresponding to different incident angles. FIG. 8 illustrates three inspection points 66, 68, 70. The three images captured at these locations using spatial multiplexing give effectively the same result as three separate illuminates and a flat inspection plane.

Sending the note through a curved path may also serve to accentuate features of interest. For example, tears in the surface may open which facilitates their detection.

Other types of surface manipulation may also be used for this purpose. For example, the surface may be twisted or bent at its edges by means of bevels or the like. In another example, a pressure difference may be applied across the surface to expose defects therein. For example, a partial vacuum may be applied to the surface note that may also be useful for opening tears. Alternatively, a blade of air could be used to induce a profile in the path of the note, or a vacuum could be used to pull the note into a recess to enable the edge of the surface to be examined for a discontinuity caused by a tear.

### Banknote Inspection Apparatus

The technique of dynamic photometric stereo measurement may be particularly suitable for inspecting currency, i.e. sheet-like banknotes made of paper (i.e. cotton-based) or plastic (i.e. polypropylene-based), where 2D coloured patterns may be concomitant with important 3D topographic texture. Inspection may be performed either during manufacture, e.g. as part of a process control system, or on used notes to determine if they are fit for continued circulation.

The inspection of banknotes is characterised by two particular difficulties: the size and varied nature of potential defects, and the required processing speed, since banknotes may move at a rate of up to 40 notes per second (i.e. a sheet speed of up to 10 ms⁻¹) during processing and manufacture.

The latter problem has two aspects. As the speed of the notes increases, there is an expected increase in processing demand (i.e. an increase in the volume of collected data that needs to be assessed) and a decrease in the duration of the imaging window.

A solution to the increase in processing demand is to implement a more efficient processing system, i.e. high-power computation and data handling methods. For example, the processing device used to handle the output from the cameras may comprise a dedicated Graphics Processor Units (GPU) on a parallel computing platform (e.g. Nvidia CUDA). Such platforms are used in high-performance gaming workstations. Accelerated computing is possible by splitting processes between a GPU and Central Processing Unit (CPU). Computationally intensive algorithms, such as photometric stereo with surface normal manipulation, will be offloaded to the GPU. This is facilitated by the availability of more efficient and more abundant cores apparent in Nvidia GPUs and the parallel computing platform provided by Nvidia CUDA. This arrangement may enable inspection speeds of 2 ms⁻¹ or more, e.g. up to 10 ms⁻¹. This may correspond to single note processing times in a range from 25 ms (processing while acquiring) to 3 ms (processing following acquisition).

Some pre-processing may occur at the camera or at the interface between the camera and the processor. Preferably the image capture device communicates with the processor via an interface module (e.g. a frame grabber card which uses the Camera Link protocol standard) that incorporates an FPGA to enable some data pre-processing to be done on the cards, thereby reducing the amount of data to be transferred to the workstation and speeding up the processing.

The processing time may be further reduced through use of other known data management/reduction techniques (e.g. radial lens distortion reduction and image mosaicing).

Furthermore, as the majority of 3D features and/or defects on a banknote are generally vertical in orientation, the reduced dimensionality of the multiple in-plane illuminate detection system described above with reference to FIGS. 3 to 8 is applicable. This system may allow the defects to be detected with high sensitivity and accuracy without a proportional increase in the processing demand.

In order to address the problem of limited image capture duration, the image capture device may include high performance (200 kHz) line-scan cameras or contact image sensors (CIS) (1 or more) in combination with very high intensity light sources. For example, each illuminate may comprise a very high intensity LED line light which has the ability to deliver a suitable light level for each image. For example, one such light source is a CORONA II product line from Chromasens GmbH. High intensity light is desirable because it is necessary to use very short shutter times to capture the images. For surfaces moving at 10 m/s, for example, it may be desirable to capture a line with an exposure time of around 5 microseconds. The exact brightness will depend upon the response of the camera sensor. Each LED may output a collimated beam to enable the surface to be illuminated from a distance at a specified angle.

The overall apparatus for performing dynamic photometric stereo inspection of banknotes may use the apparatus shown in FIG. 6 (discussed above). The apparatus may be implemented with two or more illuminates (four are illustrated in FIG. 6). It may be preferable to use three or more in-plane illuminates to take advantage of the enhanced data capture concept discussed above.

In a preferred embodiment, the banknote inspection apparatus makes use of a methodology that combines two known dynamic photometric stereo techniques [5, 6]. These techniques are known as narrow band infrared (or colour) photometric stereo (NIRPS) and spatially multiplexed photometric stereo (SMPS), and are discussed below.

1. Narrow Band Infrared (or Colour) Photometric Stereo

In a non-static scene the observation of the same point at the same location may not be possible if there is a temporal difference between observations. Images captured at separate times are likely to be subject to some degree of mis-registration and this in turn is likely to decouple the consistency of the Lambertian brightness-gradient based relationship [9] between the corresponding pixels of the photometrically disparate images. To overcome these issues, the banknote inspection apparatus of the present invention may capture multiple images of banknotes instantaneously, i.e. with spectral and spatial multiplexing rather than a temporal difference.

Spectral multiplexing employs illumination with different colours or frequencies of light with corresponding camera filters, and thereby offers the advantages of not needing high-speed light switching as in temporal multiplexing. However, a number of limitations usually apply when attempting to use a broadband colour photometric stereo approach.

Firstly, when deploying widely spaced channels of visible light, a coupling is found to exist between surface colour and surface gradient, in which it becomes difficult to determine whether an observed surface colour is due to an unknown arbitrary surface reflectance or whether it is due to unknown surface gradient. The problem arises due to the fact that similar components of coloured light may be reflected in similar proportions, both for a surface of particular colour or alternatively for a surface of a particular inclination. For example, a surface appearing blue to an observer may be either a white surface inclined towards a blue light or blue surface receiving equal illumination form three lights, one red, one green and one blue.

Secondly, in order to use a standard RGB colour camera, some 100 nm must separate each colour channel. This means that a surface of fixed arbitrary colour will appear at differing intensities under each coloured illuminate (e.g. a red surface will exhibit low radiance under blue illumination and high radiance under red illumination).

However, in the case of inspecting banknotes, it may be possible to overcome these problems since a full colour image of the banknote is known (or can be detected) in advance. This image can be later registered with the photometric images to resolve any potential ambiguity between colour and surface normal direction.

Alternatively the illuminates may operate in narrow frequency channels that are closely spaced at around only 20 nm intervals or less (hence the term “narrow band” photometric stereo).

Sensitivity to surface colour can be further reduced by locating the channels within the infrared (IR) region (i.e. 800-900 nm) of the spectrum. Approaching medium to long wave IR, i.e. in the wavelength range 1.4 mm to 10 mm, may further reduce sensitivity to changes in surface colour, i.e. different colours become metameric to one another. Also, it is known that both CCD and particularly CMOS cameras have excellent response in the IR region of the spectrum. Using this approach, surface colour data may be decoupled from gradient data. In addition, if required, an additional now decoupled superimposed white channel (i.e. visible light signal without any IR) may be simultaneously included to provide fully registered colour data. The approach is discussed in more detail in WO 03/014214, which is incorporated herein by reference.

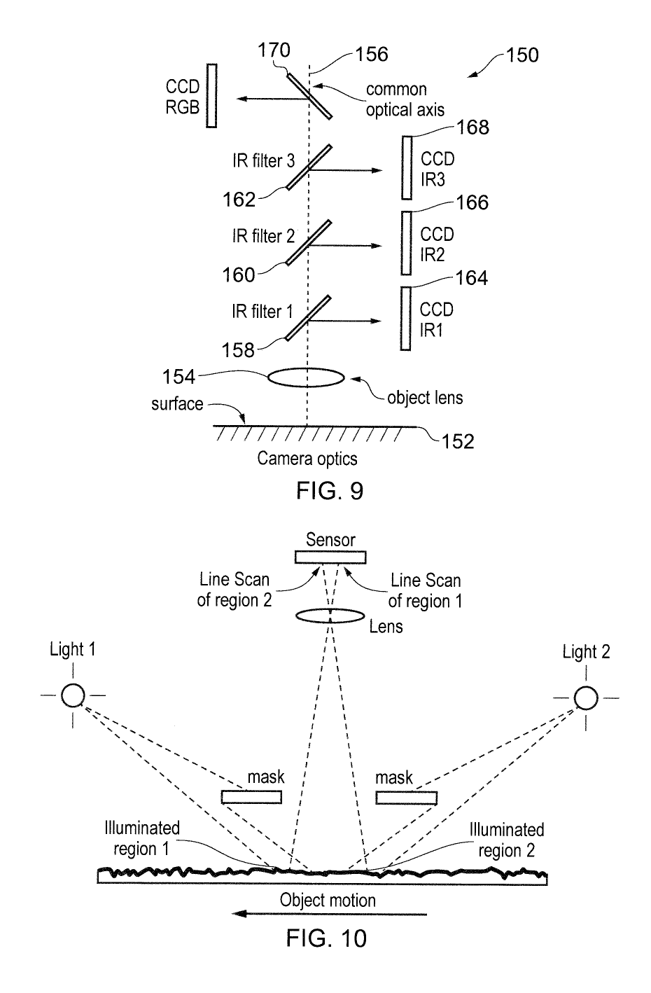

FIG. 9 shows the detail of an optical assembly 150 used in a NIRPS apparatus. Reflected radiation from the inspection surface 152 is received in an object lens 154 of a image capture device. In this embodiment, the incident light is received from four illuminates: three narrow band IR illuminates and a white light illuminate. The incident light is delivered from all illuminates simultaneously. In order to separate the different signals, a plurality of infra red filters 158, 160, 162 are mounted in series along a common optical axis 156 beyond the object lens 154. Each infra red filter 158, 160, 162 acts to reflect a predetermined narrow band of infra red light on to a respective CCD sensor 164, 166, 168. The filters transmit radiation having wavelengths outside their respective band. A mirror 170 reflects the white light that is transmitted through the IR filters onto an RGB CCD to obtain the coloured image for registration.

2. Spatially Multiplexed Photometric Stereo

Spatial multiplexing involves separate images of the same surface location being acquired at different points in space. Image acquisition at the separate locations occurs simultaneously, so in order to register images between viewing positions the scan lines of the digital camera must be carefully synchronised with the velocity of the moving surface of the banknotes. Therefore the relative movement between image system and object must be precisely controlled.

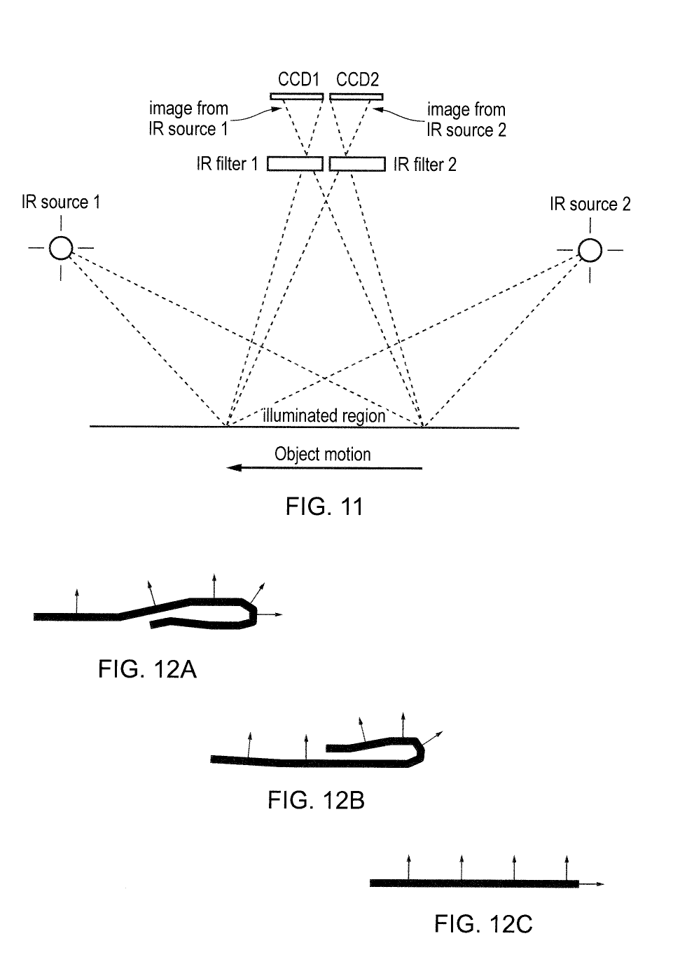

In practice the separate views may be closely spaced and imaged within a single camera array. However, for three lights or more, the lighting arrangement may be awkward to implement, since closely spaced and isolated bands of directional illumination must be produced. FIG. 10 shows a schematic setup using two lights producing strips of illumination that extend into the plane of the drawing. As depicted in FIG. 10, spatial multiplexing requires the illuminated areas to be kept completely separate, which may be impractical or have space implications. At the same time, a limitation of the NIRPS technique is the inherent complexity of camera optics, as shown in FIG. 9. These problems may be overcome by adopting a hybrid approach. Here images are isolated both in terms of spectral frequency and also by a close spatial displacement of one or two lines of pixels. A schematic configuration is shown in FIG. 11. This allows for considerable simplification of camera and optics. Instead of using multiple CODs arranged off a single optical axis, adjacent CCDs (as shown) or adjacent regions of a single CCD may be used (CCDs are shown but the sensors could employ CMOS or other sensor technology, as appropriate). As with spectral multiplexing, the various illuminates may be flooded simultaneously into the inspection area, simplifying illumination in comparison with spatial multiplexing techniques, while channel separation takes place at the camera.

The dynamic photometric stereo arrangement described above employs infrared light for illustrative purposes. The illumination in the present invention can be of any frequency, and a bump map and albedo will still be produced. However it is important to note that the albedo image generated will be for the surface as illuminated under the wavelength of illumination used in the dynamic photometric stereo. If this were infrared and a realistic white light albedo were required, then an additional colour camera would be employed (either line scan or area scan), with suitable illumination (such as broadband or ‘white’ light) for producing the realistic colour albedo.

The rich 3D and 2D data set that will be made available from a technique such as NIRPS and/or SMPS, will enable the fold to be detected reliably, thereby providing considerable technological and cost benefits.

These techniques may also enable other banknote characteristics to be detected, e.g. unfit holograms (scratches, excessively crumpled) and heavy crumpled (limp) banknotes. For example, 3D data may be useful for detecting the presence of transparent tape and differentiating between a closed tear and a simple mark on the note.

Furthermore, the inspection technique may be applied to check security features of banknotes. Banknote security is a critical issue for the currency supply chain industry. Current security features include covert and overt elements, both visible and non-visible to the naked eye. The application of NIRPS/SMPS methodology in particular may enable quantifiable detection of a combination of overt and covert 2D or 3D characteristics. For example, raised features on the surface of the banknote may be measured with high resolution in 3D. The resulting bump map will provide auditable datasets. The photometric stereo technique also offers the potential to measure features in both 2D (albedo) and 3D (bump maps) with very high resolutions that are not available when using other techniques. The resolution of surface recovery with photometric stereo is limited only by the resolution of the camera and lens arrangement; therefore, if required, the morphology of 3D surface features could be recovered, and modelled, at very high resolutions.

Furthermore, 3D textures or patterns located under a transparent layer such as a transparent polymer, so that no 3D texture actually exists at the note surface, may also be recoverable in 3D by employing the photometric stereo approach with suitable wavelengths of light. Also, if required the bump map gradients can be integrated to reconstruct height maps of features.

### Data Analysis—Bump Map Modelling Considerations

Another advantage of the dynamic photometric stereo technique is the ability to generate both qualitative and quantitative information about the surface being inspected. In the context of inspecting banknotes, this may mean analysing any of an albedo, a bump map or a shadow pattern to identify and quantify defects that are detected. The method may be able to classify the defect type, e.g. fold, hole, tear, soiling or other foreign matter (e.g. tape). The quantification may comprise an analysis of the size or position of the defect, and may be based on threshold values which mark the boundary between what is an acceptable defect and what is not (e.g. a rip beyond a certain size may in fact make a banknote cease to be legal tender).

The data analysis may comprise a step of modelling detected features of interest on the inspected surface. This type of processing differs from conventional image processing, which involves analysis of changes in intensities of pixels in bitmap images. In contrast, the present invention bases its analysis on a bump map, which comprises a dense array of surface normals. The analysis may be performed on the behaviour of the angle of the surface normal, e.g. changes that occur in the gradient of the surface. This is implemented in terms of analysis/modelling of the components of the surface normal relative to the x and y axes by employing techniques that range from curve fitting through to AI techniques such as neural networks, i.e. to convert the surface normal angle data in a discrete or continuous state ready for modelling.

The idea above is illustrated in FIGS. 12A to 12C. FIGS. 12A and 12B shows schematically a cross-section through a folding portion of a sheet of material. The sense of folding is different in FIG. 12A from FIG. 12B. FIG. 12A is an underfold whereas FIG. 12B is an overfold. If one considers the surface normal vectors in a line on the banknote that passes through the fold, and is perpendicular to it, it can be appreciated that the components of these vectors, in a plane that passes through this line and is perpendicular to the surface of the banknote, change with the curve of the banknote.

In the case of FIGS. 12A and 12B, the curves may be modelled, e.g. using polynomial equations that are fitted to the curves. Statistical techniques such as regression analysis allow quantification of how well the polynomials fit the surfaces; and a good fit obtained in the form of a high correlation coefficient.

In contrast, FIG. 12C shows the case where a corner is torn rather than folded. Here there is an interruption in the continuous surface at the tear (i.e. a step change in gradient), so that a good fit of the polynomial cannot be obtained and there is a relatively low correlation coefficient. This enables reliable identification and quantification of both folded and torn corners.

### REFERENCES

[1] M. L. Smith, T. Hill, G. Smith, Surface texture analysis based upon the visually acquired perturbation of surface normals, Image and Vision Computing 15 (1997) 949-955.
[2] M. L. Smith, The analysis of surface texture using photometric stereo acquisition and gradient space domain mapping, Image and Vision Computing 17 (1999) 1009-1019.
[3] M. L. Smith, G. Smith, T. Hill, Gradient space analysis of surface defects using a photometric stereo derived bump map, Image and Vision Computing 17 (1999) 321-332.
[4] M. L. Smith, Surface inspection techniques—using the integration of innovative machine vision and graphical modelling techniques, Professional Engineering Publishing, ISBN 1-86058-292-3, 2000.
[5] M. L. Smith, L. N. Smith, A. R. Farooq, Dynamic Photometric Stereo—A New Technique for Moving Surface Analysis, Image and Vision Computing 23 (2005) 841-852.
[6] A. R. Farooq, M. L. Smith, L. N. Smith and P. S. Midha, Dynamic Photometric Stereo for On Line Quality Control of Ceramic Tiles, Computers in Industry, Vol. 56, 8-9, 2005.
[7] R. D. Wedowski, G. Atkinson, M. L. Smith and L. N. Smith, On-line deflectometry: A novel approach for the on-line reconstruction of specular freeform surfaces, Optics and Lasers in Engineering, Elsevier, 2011.
[8] Wedowski R. D., Atkinson G. A, Smith M. L. and Smith L. N, A system for industrial on-line inspection of curved specular surfaces, Optics and Lasers in Engineering, 50 (2012) 632-644.
[9] B. K. P. Horn, Understanding image intensities, Artificial Intelligence 8 (1977) 201-231.

1. A method for inspecting a surface, the method comprising:
illuminating a surface with three or more inspection beams, each inspection beam being output from a respective illuminate, the illuminates being spaced from each other over the surface;
obtaining a plurality of digital images of the surface from a digital image capturing device; and
calculating a magnitude and a direction for a surface normal component at each of a plurality of inspection points on the surface based on the plurality of digital images and a predetermined incident light vector from each of the illuminates at each inspection point,
wherein the illuminates are arranged relative to the surface so that their predetermined incident light vectors are coplanar at each inspection point.

2. The method of claim 1 including moving the surface relative to the digital image capturing device while the plurality of digital images is obtained.

3. The method of claim 1, wherein calculating the magnitude and direction for the surface normal component at each inspection point comprises applying a surface reflectance lighting model to a detected light intensity at each inspection point obtained and the predetermined incident light vectors from the illuminates at each inspection point.

4. (canceled)

5. The method of claim 1 including:
generating inspection data from the magnitude and direction of the surface normal components of the inspection points; and
analyzing the inspection data to identify properties of the surface.

6. The method of claim 5, wherein analyzing the inspection data comprises any of:
comparing the behavior of the surface normal components across the surface with characteristic surface normal behavior associated with one or more surface defects, and
determining specular properties of the surface.

7. (canceled)

8. (canceled)

9. (canceled)

10. The method of claim 5, wherein the inspection data comprises one or more of:
a bump map comprising a dense array of the surface normal component directions calculated for the plurality of inspection points;
an albedo comprising a map of the surface normal component magnitudes calculated for the plurality of inspection points.

11. The method of claim 10, wherein the inspection data further includes any one or more of:
a shadow pattern obtained from one or more of the plurality of digital images;
a full colour image of the surface.

12. The method of claim 1, wherein illuminating the surface includes multiplexing the inspection beams in any of a temporal, spatial or spectral sense.

13. An apparatus for inspecting a surface, the apparatus comprising:
three or more illuminates mounted in a spaced arrangement over an inspection plane, each of the three or more illuminates being arranged to output an inspection beam to illuminate a region of the inspection plane;
a digital image capturing device having the inspection plane in its field of view; and
a processor arranged to receive a plurality of digital images from the digital image capturing device, each of the plurality of digital images including an image of the inspection plane when illuminated by an inspection beam from a respective illuminate,
wherein the processor is arranged to calculate a magnitude and a direction for a surface normal component at each of a plurality of inspection points on the inspection plane based on the plurality of digital images and a predetermined incident light vector from each of the illuminates at each inspection point, and
wherein the three or more illuminates are arranged so that their predetermined incident light vectors are coplanar at each inspection point.

14. The apparatus of claim 13 including an object conveyor arranged to move a surface to be inspected across the inspection plane while the plurality of digital images are captured by the digital image capturing device.

15. (canceled)

16. (canceled)

17. The apparatus of claim 13, wherein each of the three or more illuminates comprises a line light for outputting a planar light beam that intersects with the inspection plane along an inspection line.

18. The apparatus of claim 17, wherein the three or more illuminates output illumination in different discrete wavelength bands, and wherein the planar light beams from the three or more illuminates intersect with the inspection plane along a common inspection line.

19. The apparatus of claim 17, wherein the inspection lines of the three or more illuminates lie adjacent one another on the inspection plane.

20. (canceled)

21. (canceled)

22. The apparatus of claim 13, wherein image capture by the digital image capturing device is synchronized with the movement of a surface across the inspection plane.

23. The apparatus of claim 13, wherein the three or more illuminates include a virtual illuminate created by simultaneous illumination of the surface with the inspection beams from two or more physical illuminates.

24. An apparatus for inspecting a surface, the apparatus comprising:
an illuminate mounted adjacent to a predefined travel path for a inspection surface, the illuminate being arranged to output an inspection beam to illuminate a region of the inspection surface as it moves relative to the illuminate;
a digital image capturing device having the illuminated region of the inspection surface in its field of view; and
a processor arranged to receive a plurality of time-spaced digital images from the digital image capturing device,
wherein the region of the inspection surface in the field of view of the digital image capturing device is curved;
wherein the processor is arranged to calculate a magnitude and a direction for a surface normal component at each of a plurality of inspection points on the inspection surface based on the time-spaced plurality of digital images and a set of predetermined incident light vectors from the illuminate at each inspection point in each of the time-spaced plurality of digital images, and
wherein the set of predetermined incident light vectors for each inspection point are coplanar.

25. An inspection apparatus for banknotes, comprising:
a feed mechanism for conveying a banknote across an inspection plane; and
a photometric stereo measurement system arranged to detect a surface topography of the banknote as it passes across the inspection plane; and
an analysis processor arranged to identify defects in the banknote from the surface topography.

26. The inspection apparatus of claim 25, wherein the photometric stereo measurement system comprises:
a plurality of illuminates mounted in a spaced arrangement over the inspection plane, each of the plurality of illuminates being arranged to output an inspection beam to illuminate a region of the inspection plane; and
a digital image capturing device having the inspection plane in its field of view,
wherein the digital image capturing device is arranged to capture a plurality of images, each image being of the surface in the inspection plane when illuminated by an inspection beam from a respective illuminate.

27. The inspection apparatus of claim 26, wherein the analysis processor is arranged to:
calculate a magnitude and a direction for a surface normal component at each of a plurality of inspection points on the inspection plane based on the plurality of digital images and a predetermined incident light vector from each of the illuminates at each inspection point;
generate inspection data from the magnitude and direction of the surface normal components of the inspection points, and to analyze the inspection data to identify defects in the banknote; and
determine specular properties of the banknote from the surface topography.

28. (canceled)

29. (canceled)

30. (canceled)

31. The inspection apparatus of claim 27, wherein the inspection data comprises one or more of:
a bump map comprising a dense array of the surface normal component directions calculated for the plurality of inspection points;
an albedo comprising a map of the surface normal component magnitudes calculated for the plurality of inspection points;
a shadow pattern obtained from one or more of the plurality of digital images; and
a full color image of the surface.

32. (canceled)

33. A method of analyzing surface topography of a moving surface, the method comprising:
obtaining a bump map comprising a dense array of surface normal component directions for a plurality of inspection points on a surface;
modelling the behavior of the surface normal component directions in a region of the surface;
identifying a property of the surface based on the modelled behavior.

34. The method of claim 33, wherein modelling the behavior of the surface normal component directions includes any one or more of:
fitting the surface normal directions across the region to a polynomial expression;
fitting the rate of angular change of the surface normal directions across the region to a polynomial expression; and
running a sub-routine comprising the steps of:
creating a computer-generated three-dimensional rendering of the region from the bump map;
generating a first view of the computer-generated three-dimensional rendering using a first illumination location; and
generating a second view of the computer-generated three-dimensional rendering using a second illumination location that is different to the first illumination location,
wherein identifying a property of the surface includes comparing the first view with the second view.

35. (canceled)

36. The method of claim 33, wherein identifying a property of the surface includes any one or more of:
comparing the modelled behavior with predetermined characteristic behavior of known surface properties; and
quantifying a magnitude of a surface defect.

37. (canceled)

38. (canceled)

39. (canceled)

40. (canceled)

41. (canceled)

42. (canceled)

43. The method of claim 33, wherein the surface is the surface of a banknote, and wherein the method includes using the identified property of the surface to determine the fitness of the banknote.
